(19) United States
(12) Patent Application Publication
(10) Pub. No.: US 2022/0376291 A1
(43) Pub. Date: Nov. 24, 2022

(54) COMPOUND AND BATTERY COMPRISING THE SAME

(71) Applicants: IDEMITSU KOSAN CO.,LTD., Chiyoda-ku (JP); OSAKA RESEARCH INSTITUTE OF INDUSTRIAL SCIENCE AND TECHNOLOGY, Izumi-shi (JP)

(72) Inventors: Atsutaka KATO, Osaka-shi (JP); Mari YAMAMOTO, Osaka-shi (JP); Masanari TAKAHASHI, Osaka-shi (JP); Futoshi UTSUNO, Sodegaura-shi (JP); Hiroyuki HIGUCHI, Sodegaura-shi (JP)

(73) Assignees: IDEMITSU KOSAN CO.,LTD., Chiyoda-ku (JP); OSAKA RESEARCH INSTITUTE OF INDUSTRIAL SCIENCE AND TECHNOLOGY, Izumi-shi (JP)

(21) Appl. No.: 17/626,939

(22) PCT Filed: Jul. 17, 2020
(86) PCT No.: PCT/JP2020/027911

§ 371 Date: Jan. 13, 2022

(30) Foreign Application Priority Data
Jul. 18, 2019 (JP) 2019-133164

(51) Int. Cl. H01M 10/0562; C01B 25/14; H01M 4/62

(52) U.S. Cl. CPC H01M 10/0562; C01B 25/14; H01M 4/621; C01P 2002/54; C01P 2006/40; C01P 2002/82; C01P 2002/72; C01P 2002/86; C01P 2004/03; H01M 2300/0068

(57) ABSTRACT

A compound comprising phosphorus atoms and sulfur atoms as constituent elements and having a peak in Raman spectroscopy, the peak being attributable to a disulfide bond bonding between two phosphorus atoms.

### TECHNICAL FIELD

The invention relates to a compound and a battery comprising the same.

### BACKGROUND ART

All-solid-state batteries, such as all-solid-state lithium ion batteries and the like, typically contain a positive electrode layer, a solid electrolyte layer (sometimes simply referred to as an “electrolyte layer”), and a negative electrode layer. By containing a binder into these layers, each layer or a stacked body thereof can be formed into a sheet.

Non-Patent Documents 1 and 2 disclose a polymerization of PS₄ on the surface of an electrode active material. Further, Non-Patent Document 3 discloses change in the chemical structure of 70Li₂S-30P₂S₅ with heat treatment.

### RELATED ART DOCUMENTS

### Non-Patent Document

[Non-Patent Document 1] Masato Sumita and 2 others, “Possible Polymerization of PS₄ at a Li₃PS₄FePO₄ Interface with Reduction of the FePO₄ Phase,” The Journal of Physical Chemistry C, Apr. 24, 2017, Vol. 121, p. 9698-9704

[Non-Patent Document 2] Takashi Hakari and 9 others, “Structural and Electronic-State Changes of a Sulfide Solid Electrolyte during the Li Deinsertion-Insertion Processes,” Chemistry of Materials, May 3, 2017, Vol. 29, p. 4768-4774

[Non-Patent Document 3] Yuichi Hasegawa, ‘Chemical structural analysis of 70Li₂S-30P₂S₅ of the sulfide-based solid electrolyte’, [online], Feb. 1, 2018, Toray Research Center, Inc. [Search on Jul. 9, 2019], Internet <URL: https://www.toray-research.co.jp/technical-info/trcnews/pdf/201802-01.pdf>

### SUMMARY OF THE INVENTION

Polyvinylidene fluoride (PVDF), carboxymethyl cellulose (CMC) and the like may be used as a binder. However, such a binder has a problem in that when the addition amount thereof is increased in order to obtain the binding property between the materials constituting the layer (e.g., composite electrode), the ionic conductivity decreases. Therefore, a compound capable of exhibiting a function as a binder while having ionic conductivity is desired.

It is an object of the invention to provide a compound which can be used as a binder for a battery and which can suppress the decrease in ionic conductivity, and a battery containing the compound.

As a result of intensive studies, the inventors have found that a compound containing phosphorus and sulfur as constituent elements and having a disulfide bond can be used as a binder having ionic conductivity, and has completed the invention.

According to one embodiment of the invention, a compound containing phosphorus and sulfur as constituent elements and having a peak in Raman spectroscopy, and the peak is attributable to a disulfide bond that bonds between two phosphorus atoms (hereinafter sometimes referred to as a “compound α”) can be provided.

According to the invention, a compound which can be used as a binder for a battery having ionic conductivity, and a battery containing the compound can be provided.

### BRIEF DESCRIPTION OF THE DRAWINGS

FIG. 1 is a diagram showing the results of powder X-ray analysis of the compound α.

FIG. 2 is a solid-state ³¹P-NMR chart of the compound α obtained in Example 3.

FIG. 3 is a Raman spectrum of the compound α.

FIG. 4 is a Raman spectra of the compound α (before and after toluene treatment).

FIG. 5 is a diagram showing the results of an ionic conductivity measurement of the compound α.

FIG. 6 is a scanning electron microscope image of the compound α before press molding.

FIG. 7 is a scanning electron microscope image of the compound α after press molding.

FIG. 8 is a photograph of a coating liquid prepared in Example 4.

FIG. 9 is a photograph of a coating liquid prepared in Example 5.

FIG. 10 is a photograph of a coating liquid prepared in Comparative Example 2.

FIG. 11 is a diagram showing the results of initial charge and discharge of a cell prepared in Example 9.

FIG. 12 is a diagram showing the results of the cycle characteristics of a cell prepared in Example 9.

FIG. 13 is a Cole-Cole plotting of a cell prepared in Example 9.

FIG. 14 is a diagram showing the results of initial charge and discharge of a cell prepared in Example 11.

FIG. 15 is a diagram showing the results of a cycle characteristics of a cell prepared in Example 11.

FIG. 16 is a solid-state ³¹P-NMR chart of the compound α obtained in Example 13.

### MODE FOR CARRYING OUT THE INVENTION

Hereinafter, a mode for carrying out the invention will be described. It should be noted that an embodiment in which two or more individual preferred embodiments of the invention described below are combined is also a preferred embodiment of the invention.

### <Compound α>

A compound α according to one embodiment of the invention contains phosphorus and sulfur as constituent elements and has a peak in Raman spectroscopy, and the peak is attributable to a disulfide bond that bonds between two phosphorus atoms.

The compound α according to one embodiment of the invention can be identified by having a peak in a Raman spectroscopy in a range of Raman shift 425 cm⁻¹ or more and 500 cm⁻¹ or less, preferably 440 cm⁻¹ or more and 490 cm⁻¹ or less, and more preferably 460 cm⁻¹ or more and 480 cm⁻¹ or less (hereinafter, sometimes referred to as a “peak A”), as well as a peak in a range of Raman shift 370 cm⁻¹ or more and less than 425 cm⁻¹, preferably 380 cm⁻¹ or more and 423 cm⁻¹ or less, and more preferably 390 cm⁻¹ or more and 420 cm⁻¹ or less (hereinafter, sometimes referred to as a “peak B”).

The presence of a disulfide bond (S—S) in the compound α according to one embodiment of the invention may be identified by the observing the peak A.

The peak A is one attributable to a disulfide bond (S—S) that bonds between two phosphorus atoms in the compound α. The peak B is one attributable to the symmetrical stretching of a P—S bond in a PS₄³⁻ unit (sometimes referred to as a PS₄ structure).

Raman spectroscopy of the compound α is carried out in the method described in Examples. In this case, it is important to carry out the Raman spectroscopy for the compound α after toluene treatment. This treatment is taken place in order to remove elemental sulfur, which may be mixed in the compound α. Elemental sulfur may have a peak at a position that overlaps with the peak A. Therefore, by removing elemental sulfur, the peak A attributable to the compound α can be well measured. The toluene treatment is carried out according to the procedure described in Examples.

It is preferable that the compound α according to one embodiment of the invention contains one or more elements selected from the group consisting of lithium, sodium, and magnesium as constituent elements. In one embodiment, these constituent elements are bonded to S in the compound α by ionic bonds.

### <Binder for Battery>

A binder for a battery (hereinafter referred to as a battery binder (A)) according to one embodiment of the invention contains the above-mentioned compound α. The battery binder (A) may further contain halogen. The halogen may be a halogen attributable to an oxidizing agent or the like used in the production of the compound α.

The halogen may be one or more selected from the group consisting of iodine, fluorine, chlorine, and bromine. The halogen may be iodine or bromine.

The form of the halogen described above is not particularly limited, and may be, for example, one or more selected from the group consisting of halogen salts with one or more elements selected from the group consisting of lithium, sodium, magnesium and aluminum, and halogen simple substances. Examples of the salt include, for example, LiI, NaI, MgI₂, AlI₃, LiBr, NaBr, MgBr₂, AlBr₃, and the like. Among these, LiI and LiBr are preferred from the viewpoint of the ionic conductivity. Examples of the halogen simple substance indude iodine (I₂), fluorine (F₂), chlorine (Cl₂), bromine (Br₂), and the like. Among these, iodine (I₂) and bromine (Br₂) are preferred from the viewpoint of reducing corrosion when remaining in the binder (A).

In one embodiment, the battery binder (A) can have higher ionic conductivity by containing halogen as the salt described above.

The content of the compound α in the battery binder (A) is not particularly limited, but for example, from the viewpoint of the binding strength of an active material or a solid electrolyte described below, the content is 50% by mass or more, 60% by mass or more, 70% by mass or more, 80% by mass or more, 85% by mass or more, 90% by mass or more, 95% by mass or more, 98% by mass or more, 99% by mass or more, 99.5% by mass or more, 99.8% by mass, or 99.9% by mass, relative to the total mass of the battery binder (A) of 100% by mass.

The content of the halogen-containing substance (the halogen simple substances and the halogen compounds) in the battery binder (A) is not particularly limited, and for example, from the viewpoint of the conductivity of ions serving as carriers and the binding strength of an active material and a solid electrolyte, the content may be 50% by mass or less, 40% by mass or less, 30% by mass or less, 20% by mass or less, 15% by mass or less, 10% by mass or less, 8% by mass or less, 5% by mass or less, 3% by mass or less, 2% by mass or less, 1% by mass or less, 0.5% by mass or less, 0.1% by mass or less, 0.05% by mass or less, or 0.01% by mass or less, relative to the total mass of the battery binder (A) of 100% by mass.

Note that substantially 100% by mass of the battery binder (A) may be the compound α, or the compound α and the halogen-containing substance.

The battery binder (A) can be used for various batteries. Examples of the battery indude a secondary battery such as a lithium ion battery, for example. The battery may be an all-solid-state battery. The “binder” may be blended into any constituent in such a battery, for example, one or more constituents selected from the group consisting of an composite electrode layer for a battery and an electrolyte layer for a battery, and exhibit a binding property (binding strength) for binding and maintaining integrity of other components to each other induded in the constituent (for example, a layer).

A conventional composite electrode layer for a battery (e.g., a positive electrode or a negative electrode described later) has difficultly in following expansion and shrinkage (volume change) of an electrode active material accompanying charge and discharge or the like, so that problems such as capacity deterioration are likely caused. In an electrolyte layer in close proximity to the composite electrode layer for a battery, problems such as deterioration affected by the volume change of the composite electrode layer for a battery, may also be caused. On the other hand, in the composite electrode layer fora battery or the electrolyte layer for a battery which uses the battery binder (A), the volume change can be absorbed by the flexibility of the battery binder (A), so that the capacity deterioration and the like can be prevented. Thus, such a battery can exhibit excellent cycle characteristics. In addition, since the battery binder (A) itself may have ionic conductivity, even when the amount of the battery binder (A) added is increased in order to enhance the binding property between the materials constituting the layers (e.g., the composite electrode), the lowering of ionic conductivity can be suppressed, and the battery characteristics can be exhibited satisfactorily. Further, in one embodiment, since the battery binder (A) is superior in heat resistance compared to an ordinary organic binder or a polymer solid electrolyte (e.g., polyethylene oxide or the like), the operating temperature range of the battery can be enlarged.

### <Composite Electrode Layer for Battery or Electrolyte Layer for a Battery>

The composite electrode layer for a battery or the electrolyte layer for a battery according to one embodiment of the invention contains the above-mentioned battery binder (A).

In one embodiment, the battery binder (A) is unevenly distributed or uniformly distributed (dispersed) within the composite electrode layer for a battery or the electrolyte layer for a battery. In one embodiment, the uniform distribution (dispersion) of the battery binder (A) within the layer maintains the integrity of the layer more better.

The composite electrode layer for a battery or the electrolyte layer for a battery preferably contains a solid electrolyte other than the battery binder (A) (hereinafter, referred to as a solid electrolyte (B)). The solid electrolyte (B) is not particularly limited, and for example, an oxide solid electrolyte or a sulfide solid electrolyte can be used. Among these, a sulfide solid electrolyte is preferable. Specifically, examples of the sulfide solid electrolyte indude a sulfide solid electrolyte having a crystal structure such as an argyrodite-type crystal structure, a Li₃PS₄ crystal structure, a Li₄P₂S₆ crystal structure, a Li₇P₃S₁₁ crystal structure, a Li₄₋ₓGe₁₋ₓPₓS₄ based thio-LISICON Region II type crystal structure, a crystal structure similar to a Li₄₋ₓGe₁₋ₓPₓS₄ based thio-LISICON Region II type (hereafter, sometimes abbreviated as a RII-type crystal structure), and the like.

Examples of the composite electrode layer for a battery indude a positive electrode, a negative electrode, and the like.

When the composite electrode layer for a battery is a positive electrode, the positive electrode may further contain a positive electrode active material. The positive electrode active material is a material capable of intercalating and desorbing lithium ions, and publidy known as a positive electrode active material in the field of batteries can be used.

Examples of the positive electrode active material include metal oxides, sulfides, and the like. Sulfides indude metal sulfides and non-metal sulfides.

The metal oxide is, for example, a transition metal oxide. Specifically, examples of the metal oxide include V₂O₅, V₆O₁₃, LiCoO₂, LiNiO₂, LiMnO₂, LiMn₂O₄, Li(NiₐCo_{b}Mn_{c})O₂ (where 0<a<1, 0<b<1, 0<c<1, a+b+c=1), LiNi_{1-Y}Co_{Y}O₂, LiCo_{1-Y}Mn_{Y}O₂, LiNi_{1-Y}Mn_{Y}O₂ (where 0≤Y<1), Li(NiₐCo_{b}Mn_{c})O₄ (where 0<a<2, 0<b<2, 0<c<2, a+b+c=2), LiMn_{2-Z}Ni_{Z}O₄, LiMn_{2-Z}Co_{Z}O₄ (where 0<Z<2), LiCoPO₄, LiFePO₄, CuO, Li(NiₐCo_{b}Al_{c})O₂ (where 0<a<1, 0<b<1, 0<c<1, a+b+c=1), and the like.

Examples of the metal sulfide include titanium sulfide (TiS₂), molybdenum sulfide (MoS₂), iron sulfide (FeS, FeS₂), copper sulfide (CuS), nickel sulfide (Ni₃S₂), and the like.

In addition, examples of the metal oxide include bismuth oxide (Bi₂O₃), bismuth lead oxide (Bi₂Pb₂O₅), and the like.

Examples of the non-metal sulfide include organic disulfide compounds, carbon sulfide compounds, and the like.

In addition to those mentioned above, niobium selenide (NbSe₃), metal indium, and sulfur can also be used as the positive electrode active material.

When the composite electrode layer for a battery is a negative electrode, the negative electrode may further contain a negative electrode active material.

As the negative electrode active material, carbon materials such as graphite, natural graphite, artificial graphite, hard carbon, and soft carbon; composite metal oxides such as a polyacene-based conductive polymer and lithium titanate; compounds forming an alloy with lithium such as silicon, a silicon alloy, a silicon composite oxide, tin, and a tin alloy; or the like, which is usually used in a lithium ion secondary battery, can be used. Among these, the negative electrode active material preferably contains one or more selected from the group consisting of Si (silicon, silicon alloy, silicon-graphite complex, silicon composite oxide, and the like) and Sn (tin, and tin alloy).

One or both of the positive electrode and the negative electrode may contain a conductive aid. When the electron conductivity of the active material is low, it is preferable to add a conductive aid. As a result, the rate characteristic of the battery can be increased.

Specific examples of the conductive aid are preferably a carbon material and a substance containing at least one element selected from the group consisting of nickel, copper, indium, silver, cobalt, magnesium, lithium, chromium, gold, ruthenium, platinum, beryllium, iridium, molybdenum, niobium, osmium, rhodium, tungsten, and zinc, and more preferably a carbon simple substance having high conductivity, carbon materials other than the carbon simple substance; and a metal simple substance, a mixture, or a compound containing nickel, copper, silver, cobalt, magnesium, lithium, ruthenium, gold, platinum, niobium, osmium, or rhodium.

Specific examples of the carbon material include carbon blacks such as Ketjenblack, acetylene black, Dencablack, thermal black, and channel black; graphite, carbon fibers, activated carbon, and the like, which may be used alone or in combination of two or more kinds. Among them, acetylene black including Dencablack, which have high electron conductivity, and Ketjenblack are suitable.

The electrolyte layer contains a battery binder (A) and may contain a solid electrolyte (B) other than the battery binder (A) as an arbitrary component.

The composition of the positive electrode is not particularly limited, and for example, the mass ratio of a positive electrode active material: a solid electrolyte (B): a battery binder (A): a conductive aid may be 50 to 99:0 to 30:1 to 30:0 to 30.

Of the positive electrode, 30% by mass or more, 50% by mass or more, 80% by mass or more, 90% by mass or more, 95% by mass or more, 98% by mass or more, or 99%% by mass or more may be occupied by a positive electrode active material, a solid electrolyte (B), a battery binder (A), and a conductive aid.

The composition of the negative electrode is not particularly limited, and for example, the mass ratio of a negative electrode active material:a solid electrolyte (B):a battery binder (A):a conductive aid may be 40 to 99:0 to 30:1 to 30:0 to 30.

Of the negative electrode, 30% by mass or more, 50% by mass or more, 80% by mass or more, 90% by mass or more, 95% by mass or more, 98% by mass or more, and 99% by mass or more may be occupied by a negative electrode active substance, a solid electrolyte (B), a battery binder (A), and a conductive aid.

The composition of the electrolyte layer is not particularly limited, and for example, the mass ratio of a solid electrolyte (B):a battery binder (A) may be 99.9:0.1 to 0:100.

When the mass ratio of the solid electrolyte (B) is 0, the battery binder (A) can also serve as a solid electrolyte.

Of the electrolyte layer, 30% by mass or more, 50% by mass or more, 80% by mass or more, 90% by mass or more, 95% by mass or more, 98% by mass or more, 99% by mass or more, or 99.9% by mass or more may be occupied by a solid electrolyte (B) and a battery binder (A).

A method of forming a layer containing the compound α, for example, a method of forming each layer constituting the battery described above, is not particularly limited, and examples of the method include a coating method and the like. In the coating method, a coating liquid in which a component contained in each layer is dissolved or dispersed in a solvent can be used. As a solvent contained in the coating liquid, an open-chain, cyclic, or aromatic ether (e.g., dimethyl ether, dibutyl ether, tetrahydrofuran, anisole, or the like), an ester (e.g., ethyl acetate, ethyl propionate, or the like), an alcohol (e.g., methanol, ethanol, or the like), an amine (e.g., tributylamine, or the like), an amide (e.g., N-methylformamide, or the like), a lactam (e.g., N-methyl-2-pyrrolidone, or the like), hydrazine, acetonitrile, or the like can be used. A layer (dried coating film) is formed by application of the coating liquid, followed by drying to evaporate the solvent. From the viewpoint of ease of evaporation of the solvent, anisole is preferred. The method of drying is not particularly limited, and for example, one or more means selected from the group consisting of heat-drying, blow-drying, and drying under reduced pressure (including vacuum-drying) can be used.

The member to which the coating liquid is applied is not particularly limited. The formed layer may be used in a battery together with the member, or the formed layer may be used in a battery after peeling off from the member. In one embodiment, the coating liquid for forming a positive electrode is applied on a positive electrode current collector. In one embodiment, the coating liquid for forming a negative electrode is applied on a negative electrode current collector. In one embodiment, the coating liquid for forming an electrolyte layer is applied on a positive electrode or a negative electrode. In one embodiment, the coating liquid for forming an electrolyte layer is applied on an easily peelable member, and then the formed layer is peeled off from the easily peelable member and disposed between the positive electrode and the negative electrode.

It is preferable to press the dried coating film (layer). The press may be any method that presses and compresses the layer. For example, such a press may be applied to reduce the porosity in the layer. The press apparatus is not particularly limited, and for example, a roll press, a uniaxial press, or the like can be used. A temperature at the time of pressing is not particularly limited and may be about room temperature (23° C.), or lower or higher than room temperature. By applying the press, the battery binder (A) contained in the layer is suitably deformed with its flexibility, and the formation of the interface between the composite electrode contained in the layer is promoted. As a result, the battery characteristics are further increased.

The press may be performed on a layer-by-layer or may be performed on a plurality of stacked layers (for example, a “sheet for a battery” to be described later) so as to press the plurality of layers in the stacking direction.

### <Sheet for Battery>

The sheet for a battery according to one embodiment of the invention contains at least one selected from the group consisting of the composite electrode layer and the electrolyte layer described above. By containing the compound α or a battery binder (A), the sheet for a battery exhibits excellent flexibility and is prevented from breaking or peeling from the current collector.

### <Battery>

The battery according to one embodiment of the invention contains the above-described compound α.

In one embodiment, the battery is an all-solid-state battery.

In one embodiment, the all-solid-state battery includes a stacked body containing a positive electrode current collector, a positive electrode, an electrolyte layer, a negative electrode, and a negative electrode current collector in this order. As the current collector, a plate-like body or a foil-like body, etc. formed of copper, magnesium, stainless steel, titanium, iron, cobalt, nickel, zinc, aluminum, germanium, indium, lithium or an alloy thereof, or the like can be used.

In the battery, it is preferable that one or more selected from the group consisting of a positive electrode, an electrolyte layer, and a negative electrode contain the compound α.

In the above description (and Examples described later), the case where the compound α is used for a battery is mainly described, but the invention is not limited thereto. The compound α can be widely applied for various applications because of its excellent flexibility, ionic conductivity, and the like.

### <Method of Producing Compound α>

The method of producing a compound α according to one embodiment of the invention indudes steps of:

adding an oxidizing agent to a raw material compound containing phosphorus and sulfur as constituent elements, and

reacting the raw material compound and the oxidizing agent.

By reading the above raw material compound and the oxidizing agent, the above-described compound α is obtained as a product.

A raw material compound which is the raw material of this embodiment (hereinafter referred to as a raw material compound (C)) contains phosphorus and sulfur as constituent elements.

The raw material compound (C) preferably contains one or more elements selected from the group consisting of lithium, sodium, magnesium, and aluminum as constituent elements.

In one embodiment, it is preferred that the raw material compound (C) contains a PS₄ structure. Examples of the raw material compound containing a PS₄ structure include, for example, Li₃PS₄, Li₄P₂S₇, Na₃PS₄, Na₄P₂S₇, and the like. The raw material compound (C) may contain two or more PS₄ structures, such as Li₄P₂S₇, Na₄P₂S₇ and the like. Here, when the raw material compound (C) contains two PS₄ structures adjacent to each other, the two PS₄ structures may share one S atom.

Li₃PS₄ can be produced, for example, by reacting Li₂S and P₂S₅ in the presence of a dispersion medium by a mechanochemical method (mechanical milling). Examples of the dispersion medium indude n-heptane and the like. For the mechanochemical method, for example, a planetary ball mill or the like can be used.

In one embodiment, the compound α can be produced by reacting Li₂S, P₂S₅, and the oxidizing agent in the presence of a dispersion medium (e.g., n-hexane, etc.) by a mechanochemical method (mechanical milling). Again, a planetary ball mill or the like can be used for the mechanochemical method, for example.

In the above description, Na₂S may be used in place of Li₂S.

Examples of the oxidizing agent indude, for example, a halogen simple substance, oxygen, ozone, an oxide (Fe₂O₃, MnO₂, Cu₂O, Ag₂O, etc.), an oxoacid salt (chlorate, hypochlorite, iodate, bromate, chromate, permanganate, vanadate, bismutate, etc.), a peroxide (litium peroxide, sodium peroxide, etc.), a halogenide (AgI, CuI, PbI₂, AgBr, CuCl, etc.), a cyanate (AgCN, etc.), a thiocyanate (AgSCN, etc.), and a sulfoxide (dimethylsulfoxides, etc.), and the like. In one embodiment, the oxidizing agent is preferably a halogen simple substance from the viewpoint of enhancing ionic conductivity by a metal halide generated as a by-product. The “metal halide” may be a salt of one or more elements selected from the group consisting of lithium, sodium, magnesium, and aluminum attributable to the raw material compound (C), and halogen (e.g., may be lithium halide when the raw material compound (C) contains lithium) or the like.

Examples of the halogen simple substance indude iodine (I₂), fluorine (F₂), chlorine (Cl₂), bromine (Br₂), and the like. The halogen simple substance is preferably iodine (I₂) or bromine (Br₂) from the viewpoint that higher ionic conductivity can be obtained.

The oxidizing agent may be used alone or in combination of a plurality of kinds.

In one embodiment, when the raw material compound (C) is Li₃PS₄ and the oxidizing agent is I₂, it is presumed that the reactions as shown in Reaction Schemes (1) to (3) below proceed. In one embodiment, the compound α has a P—S—S chain (a chain consisting of repeating units composed of P—S—S) (Reaction Schemes (1) and (2)). In one embodiment, a P—S—S chain of the compound α form branches (Reaction Scheme (3)). In one embodiment, two phosphorus atoms and a disulfide bond which bonds between the two phosphorus elements constitute a P—S—S chain.

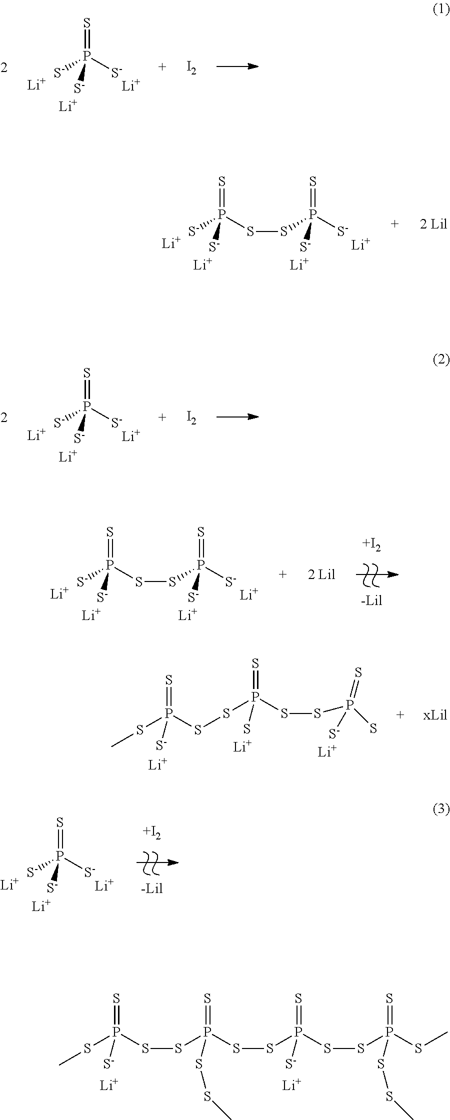

The molar ratio of Li₃PS₄ and I₂ (Li₃PS₄:I₂) which are reacted (to be blended) is not particularly limited, and may be, for example, 10:1 to 1:10, 5:1 to 1:5, 3:1 to 1:3, 2:1 to 1:2, 4:3 to 3:4, 5:4 to 4:5, or 8:7 to 7:8. Further, the blending amount of I₂ may be 0.1 part by mole or more, 0.2 part by mole or more, 0.5 part by mole or more, 0.7 part by mole or more, or 1 part by mole or more, and 300 parts by mole or less, 250 parts by mole or less, 200 parts by mole or less, 180 parts by mole or less, 150 parts by mole or less, 130 parts by mole or less, 100 parts by mole or less, 80 parts by mole or less, 50 parts by mole or less, 30 parts by mole or less, 20 parts by mole or less, 15 parts by mole or less, 10 parts by mole or less, 8 parts by mole or less, 5 parts by mole or less, 3 parts by mole or less, or 2 parts by mole or less, based on 100 parts by mole of Li₃PS₄. The larger the proportion of I₂, the longer the P—S—S chain can be extended.

In addition, the above relationship of the molar ratio can be applied not only when Li₃PS₄ and I₂ are reacted, but also when, for example, a raw material compound containing a PSₘ (m=3, 3.5, or 4) unit structure such as a PS₄ structure (or raw material compounds of the raw material compound; for example, a combination of Li₂S and P₂S₅, a combination of Na₂S and P₂S₅, and the like) and a halogen simple substance are reacted.

In the step of reacting the raw material compound (C) and the oxidizing agent (reaction step), it is preferable to react the raw material compound (C) and the oxidizing agent using one or more energies selected from the group consisting of physical energy, thermal energy, and chemical energy.

In the reaction step, it is preferable that the raw material compound (C) and the oxidizing agent be reacted using energy induding physical energy. Physical energy can be supplied, for example, by using a mechanochemical method (mechanical milling). For the mechanochemical method, for example, a planetary ball mill and the like can be used.

In the mechanochemical method using a planetary ball mill and the like, the treatment conditions are not particularly limited, and for example, the rotation speed may be 100 rpm to 700 rpm, the treatment time may be 1 hour to 100 hours, and the ball size may be 1 mm to 10 mm in diameter.

In the reaction step, it is preferable that the raw material compound (C) and the oxidizing agent be reacted in a liquid. In this case, the raw material compound (C) and the oxidizing agent can be reacted in the presence of a dispersion medium. It is preferable to react the raw material compound (C) and the oxidizing agent by a mechanochemical method (mechanical milling) in the presence of a dispersion medium, from the viewpoint of increasing reactivity by mechanical energy.

Examples of the dispersion medium include an aprotic liquid and the like. Examples of the aprotic liquid are not particularly limited and include, for example, open-chain or cyclic alkanes preferably induding 5 or more carbon atoms such as n-heptane; aromatic hydrocarbons such as benzene, toluene, xylene, and anisole; open-chain or cyclic ethers such as dimethyl ether, dibutyl ether, and tetrahydrofuran; alkyl halides such as chloroform and methylene chloride; esters such as ethyl propionate; and the like.

In one embodiment, when the raw material compound (C) and the oxidizing agent are reacted in a liquid, one or both of the raw material compound (C) and the oxidizing agent can be reacted in a state of being mixed with a solvent.

As the solvent, a dispersion medium capable of dissolving one or both of the raw material compound (C) and the oxidizing agent among the above-described dispersion media can be used, and for example, anisole, dibutyl ether, and the like are suitable.

Even in such a solution, the raw material compound (C) and the oxidizing agent can be reacted using one or more energies selected from the group consisting of physical energy such as stirring, milling, ultrasonic vibration, and the like, thermal energy, and chemical energy. For example, when thermal energy is used, the solution can be heated. The heating temperature is not particularly limited and may be, for example, 40 to 200° C., 50 to 120° C., or 60 to 100° C.

In the reaction step, the compound α can be produced by oxidizing the raw material compound (C) with the oxidizing agent.

When the compound α is produced by the reaction in a liquid, a liquid (dispersion medium or solvent) can be removed, if necessary. A solid (powder) of the compound α can be obtained by removing the liquid. The method of removing the liquid is not particularly limited, and examples thereof include drying, solid-liquid separation, and the like. Two or more of them may be combined.

When solid-liquid separation is used, the compound α may be reprecipitated. At this time, a liquid containing the compound α may be added to a poor solvent (a poor solvent for the compound α) or a non-solvent (a solvent which does not dissolve the compound α), to collect the compound α as a solid (solid phase). For example, a method in which n-heptane is added as a poor solvent to an anisole solution containing the compound α and solid-liquid separation is performed can be given. The solid-liquid separation means is not particularly limited, and examples thereof include an evaporation method, a filtration method, and a centrifugal separation method. When solid-liquid separation is used, an effect of increasing purity is obtained.

In one embodiment, LiI is by-produced with the production of the compound α. This LiI may or may not be separated from the compound α. As mentioned above, by leaving LiI as a mixture, the compound α may have higher ionic conductivity.

Here, the crystal phase of LiI may be, for example, c-LiI (cubic) (ICSD 414244), h-LiI (hexagonal) (ICSD 414242), or the like. Usually, as a method of producing the compound α, when a mechanochemical method (mechanical milling) is used, the crystal phase becomes c-LiI (cubic), and when a method of reacting in a liquid (preferably in a solution) is used, the crystal phase becomes h-LiI (hexagonal).

The crystal phase of LiI can be determined by powder X-ray diffraction or solid-state ⁷Li-NMR measurements. In solid-state ⁷U-NMR measurements, the crystal phase is determined to be c-LiI when a peak attributable to LiI (chemical shifts −4.57 ppm) is observed, and is determined to be h-LiI when a peak attributable to LiI is not observed.

### EXAMPLE

Examples of the invention will be described below, but the invention is not limited to the examples.

1. Production of Compound α

### Example 1

<Production of Li₃PS₄ Glass>

In the presence of a dispersion medium (n-heptane), 1.379 g of Li₂S (manufactured by Furuuchi Chemical Corporation, 3 N powder 200 Mesh) and 2.222 g of P₂S₅ (manufactured by Merck & Co., Inc.) were reacted under the conditions described below by a mechanochemical method (mechanical milling) using a planetary ball mill (premium line PL-7 (Fritsch)). Then, the dispersion medium was removed off by drying, to obtain a Li₃PS₄ glass (powder).

### [Conditions of Mechanical Milling]

Sample mass: 3.6 g

Process: wet milling (in 11.7 mL of n-heptane)

Ball: ZrO₂-made, 5 mm in diameter, 106 g in total mass

Pot: ZrO₂-made, 80 mL in capacity

Rotation speed: 500 rpm

Treatment time: 20 hours

### <Production of Compound α>

To Li₃PS₄ glass obtained above, I₂ (5 N irregular grains (Japan Pure Chemical Co., Ltd.)) after being crushed in a mortar was added so that a molar ratio of Li₃PS₄:I₂ was 2:1.

Subsequently, Li₃PS₄ glass and I₂ were reacted under the conditions described below in the presence of a dispersion medium (n-heptane) by a mechanochemical method (mechanical milling) using a planetary ball mill (premium line PL-7 (Fritsch)). Then, the dispersion medium was removed by drying to obtain a compound α (powder).

### [Conditions of Mechanical Milling]

Sample mass: 1 g

Process: wet milling (in 3 mL of n-heptane)

Ball: ZrO₂-made, 5 mm in diameter, 53 g in total mass

Pot: ZrO₂-made, 45 mL in capacity

Rotation speed: 500 rpm

Treatment time: 20 hours

### Example 2

A compound α (powder) was obtained in the same manner as in Example 1, except that I₂ was added to Li₃PS₄ glass so that the molar ratio of Li₃PS₄:I₂ was 4:3 in the “Production of compound α” in Example 1.

### Example 3

A compound α (powder) was obtained in the same manner as in Example 1, except that I₂ was added to Li₃PS₄ glass so that the molar ratio of Li₃PS₄:I₂ was 1:1 in the “Production of compound α” in Example 1.

### Comparative Example 1

The Li₃PS₄ glass (powder) obtained in the “Production of Li₃PS₄ glass” in Example 1 without performing the “Production of compound α”, was evaluated in the same manner as in Example 1.

2. Analysis of Compound α

It was confirmed by powder X-ray diffraction (XRD), Raman spectroscopy, and ionic conductivity measurement described below that reactions as shown in the following Reaction Schemes (1) to (3) occurred in the above Examples.

When it is assumed that the total amount of I₂ is reacted with Li₃PS₄ in accordance with the following Reaction Schemes (1) to (3), in the case of the molar ratio in Example 1 (Li₃PS₄:I₂=2:1), Li₃PS₄ can form one cross-link on average (two phosphorus atoms is linked via a disulfide bond) (one S in Li₃PS₄ is involved in the formation of the cross-link). In the case of the molar ratio in Example 2 (Li₃PS₄:I₂=4:3), Li₃PS₄ can form one-and-a-half cross-links on average (one-and-a-half S in Li₃PS₄ are involved in the formation of the cross-link). In the case of the molar ratio in Example 3 (Li₃PS₄:I₂=1:1), Li₃PS₄ can form two cross-links on average (two S in Li₃PS₄ are involved in the formation of the cross-link). The above-mentioned number of cross-links is merely the average value (it is in the case where assuming that I₂ reacts evenly to Li₃PS₄). In the case where I₂ does not react evenly to Li₃PS₄, some Li₃PS₄ may form the more crosslinks, and some other Li₃PS₄ may form the less crosslinks.

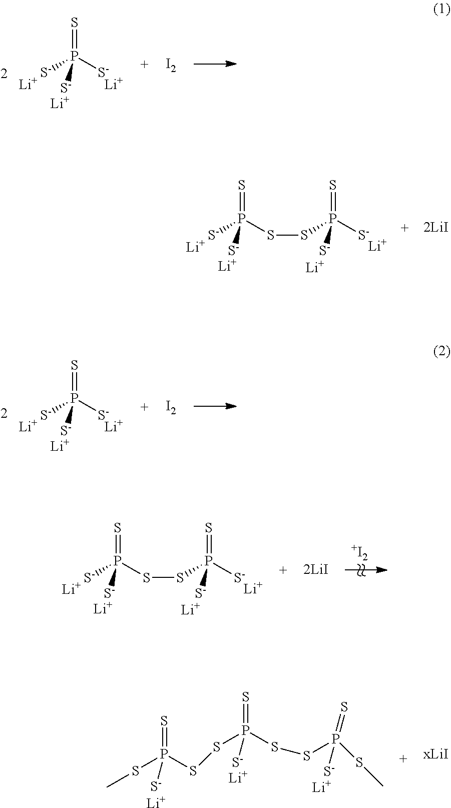

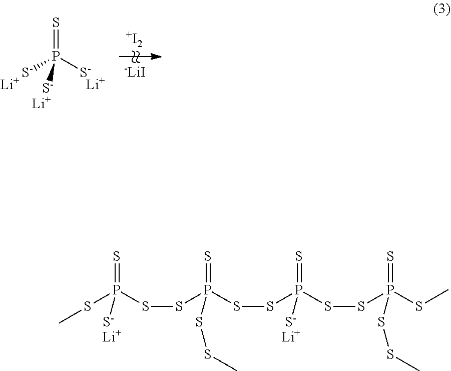

(1) Powder X-ray Diffraction (XRD)

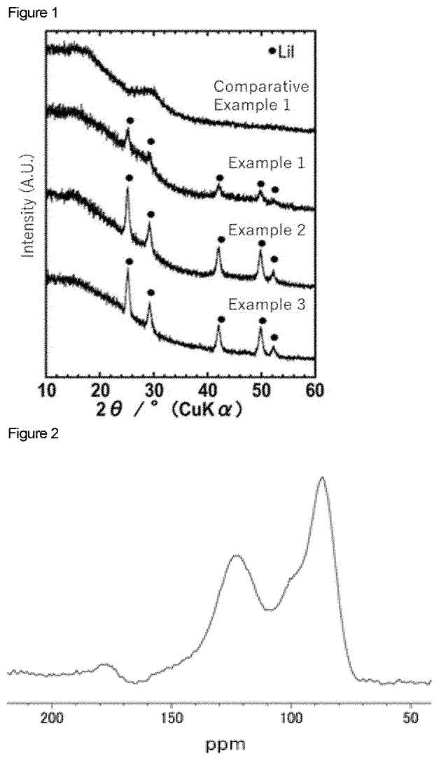

The compounds α (powders) obtained in Examples 1 to 3 and the Li₃PS₄ glass (powder) in Comparative Example 1 were subjected to XRD. The results are shown in FIG. 1.

In FIG. 1, dots were marked above the peaks attributable to LiI (2θ=25.2°, 29.2°, 42.1°, 49.9°, and 52.2°).

From FIG. 1, it was found that the compounds α of Examples 1 to 3 contained LiI. Since LiI is a product of the reaction shown in Reaction Scheme (1) or (2), it was suggested that the reaction had proceeded in Examples 1 to 3.

(2) Solid-State ³¹P-NMR Measurement

Approximately 60 mg of each of the compounds α (powders) obtained in Examples 1 to 3 was filled in an NMR-sample tube, and solid-state ³¹P-NMR spectra were obtained using the following apparatus under conditions described below. The results as to the compound α obtained in Example 3 are shown in FIG. 2.

Apparatus: ECZ 400 R apparatus (manufactured by JEOL Ltd.)

Observed nuclei: ³¹P

Observation frequency: 161.944 MHz

Measurement temperature: room temperature

Pulse sequence: single pulse (using 90° pulse)

90° pulse width: 3.8 μs

Waiting time after FID measurement until the next pulse application: 300 seconds

Rotation speed of magic angle rotation: 12 kHz

Number of integrations: 16 times

Measurement range: 300 ppm to −50 ppm

In measurement of the solid-state ³¹P-NMR spectrum, chemical shift values were obtained by using (NH₄)₂HPO₄ (chemical shift value: 1.33 ppm) as an external reference.

As shown in FIG. 2, for the compound α obtained in Example 3, a peak (signal) at a chemical shift of 120 ppm was clearly observed. This peak is thought to be attributable to a P—S—S bond.

For the compound α obtained in Example 2, a similar peak was clearly observed at a chemical shift of 120 ppm.

Also, for the compound α obtained in Example 1, a peak was observed at a chemical shift of 120 ppm, although the peak was smaller than in Examples 2 and 3.

(3) Raman Spectroscopy

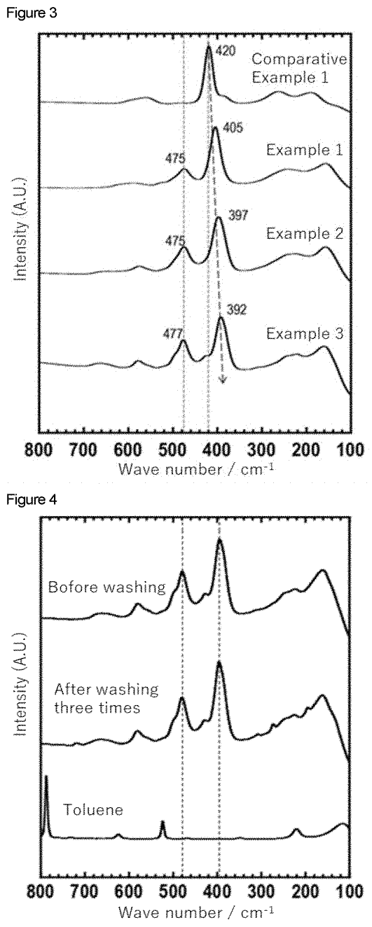

The compounds α (powder) obtained in Examples 1 to 3 and the Li₃PS₄ glass (powder) of Comparative Example 1 were subjected to microscopic Raman spectroscopy using a laser Raman spectrophotometer (NRS-3100, manufactured by JASCO Corporation). The results (Raman spectra) are shown in FIG. 3.

A peak appearing at the Raman shift 420 cm⁻¹ in Comparative Example 1 is attributable to a symmetrical stretching by a P—S bond of PS₄³⁻ unit. The peak shifted to the lower wavenumber side with the increase in the amount of I₂ in the order of Example 1, Example 2, and Example 3. For this reason, it is presumed that a P—S bond was stretched by the formation of a P—S—S bond in the product of the reaction (compound α) as shown in the Reaction Schemes (1) to (3).

In Example 12 and subsequent Examples to be described later, “LabRAM HR Evolution LabSpec 6” manufactured by HORIBA, Ltd. was used as a laser Raman spectrophotometer.

In each of Examples 1 to 3, the peak of the Raman shift near 475 cm⁻¹ that does not appear in Comparative Example 1 was observed. The peak intensity of this peak increased with increasing the addition amount of I₂. From these results, it is presumed that the peak is attributable to a disulfide (S—S) bond of a P—S—S chain.

A structure stabilization was also performed on a P—S—S—P structure by the molecular orbital method (Gaussian09: b3lyp/6-311++g**) to calculate the Raman oscillation calculation. As a result, the possibility was found that the peak of a P—S bond of a PS₄³⁻ unit and the peak due to the stretching vibration of a S—S bond of P—S—S could exist, and it was indicated that this peak was attributable to a disulfide (S—S) bond in a P—S—S chain.

### <Toluene Treatment>

In order to confirm that the peak near the Raman shift 475 cm⁻¹ described above was attributable to a disulfide (S—S) bond of a P—S—S chain rather than a disulfide (S—S) bond of sulfur simple substance, the compound α sample of Example 3 was treated with toluene three times (treatment for removing the sulfur simple substance) and then subjected to Raman spectroscopy again. The procedure of the toluene treatment is as follows. The results (Raman spectra before and after washing) are shown in FIG. 4.

### [Procedure of Toluene Treatment]

a. One g of a compound α is placed in a vial, and 10 mL of toluene (manufactured by FUJIFILM Wako Pure Chemical Corporation, ultra-dehydrated) is added, and the mixture is stirred and allowed to stand.

b. After removing the supematant liquid, 10 mL of toluene is added again to the solid content (precipitate), and the mixture is stirred and allowed to stand.

c. The operation of b above is repeated one more time.

d. After removing the supernatant liquid, the solid content (precipitate) is dried under vacuum at 60° C. for 10 hours to obtain a toluene-treated compound α.

It can be seen from FIG. 4 that the peaks near the Raman shift 475 cm⁻¹ do not substantially change before and after the toluene treatment (the other peaks do not substantially change, too). This suggests that the peaks near the Raman shift 475 cm⁻¹ are attributable to the disulfide (S—S) bond in a P—S—S chain, but not the disulfide (S—S) bond in sulfur simple substance.

(4) Ionic Conductivity

The compounds α (powder) obtained in Examples 1 to 3 and Li₃PS₄ glass (powder) of Comparative Example 1 were each placed in a cylindrical container, sandwiched with a cylindrical SUS shaft inserted from both ends of the container, and 333 MPa pressures was applied at room temperature (23° C.) to obtain a press-molded disk-shaped powder compact.

A lead wire was connected to the powder compact, and the ionic conductivity was measured while retaining the powder in the state of being pressed. “VersaStat 3” manufactured by Princeton Applied Research was used for measuring.

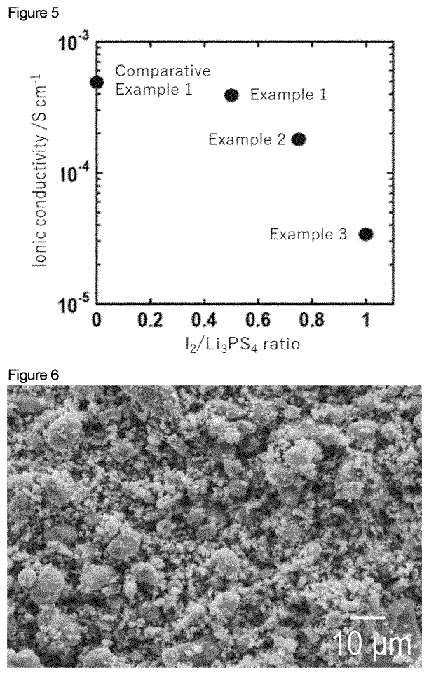

The ionic conductivity was calculated based on the thickness of the pressed powder compact. The results are shown in FIG. 5.

From FIG. 5, as the amount of I₂ (ratio of I₂/Li₃PS₄) added increased (i.e., the amount of cross-linking with disulfide bond increased), it was observed that the ionic conductivity tended to decrease. However, it was confirmed that all of the powder compact had a high ionic conductivity.

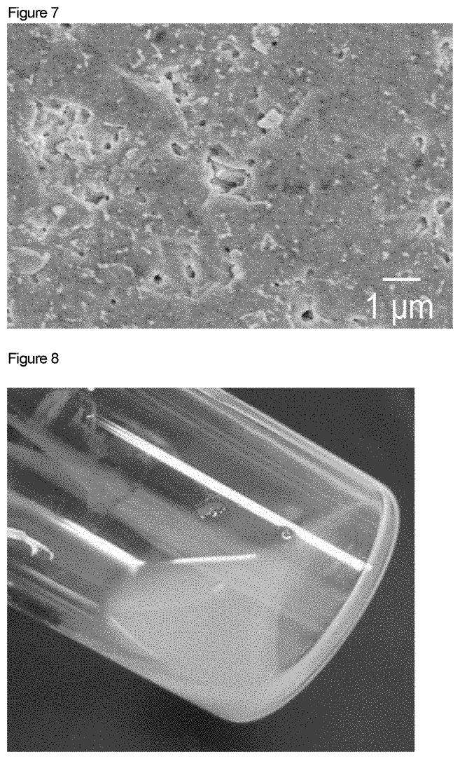

FIG. 6 shows a scanning electron microscope (SEM) image of the compound α of Example 3 (powder) before press molding. FIG. 7 shows a SEM image of the fractured surface of the compound α thereof (powder compact) after press molding.

As shown in FIG. 6, the compound α sample before press molding (powder) has a partide size of about 1 μm to 10 μm. As shown in FIG. 7, the compound α sample after press molding (powder compact) is highly densified, despite being molded under condition at room temperature. From these results, it was found that the compound α exhibit excellent deformability.

(5) Solid-State ⁷Li-NMR Measurement

Approximately 60 mg of each of the compounds α (powders) obtained in Examples 1 to 3 was placed in an NMR-sample tube, and solid-state ⁷Li-NMR measurement was performed with the following apparatus under conditions described below.

### (Apparatus and Conditions)

Apparatus: JNM-ECZ 400 R apparatus (manufactured by JEOL Ltd.)

Measured nuclei: ⁷Li

Measurement method: single pulse method

Rotation speed of MAS: 6 kHz

Waiting time after FID measurement until next 90° pulse application: 300 seconds

Chemical shift: determined using LiBr (−2.04 ppm) as an external reference

Since the peak attributable to LiI (chemical shift of −4.57 ppm) were observed in all of the compounds α obtained in Examples 1 to 3, it was determined that the crystal phase of Lil coexisting with the compound α was c-LiI.

3. Production of Coating Solution

### Example 4

Anisol was added to the compound α (powder) of Example 3 to produce an anisole solution (coating solution) containing 33% by mass of the compound α. In the anisole solution, it was confirmed that the powder of the compound α was dissolved. FIG. 8 shows a photograph of the coating solution.

### Example 5

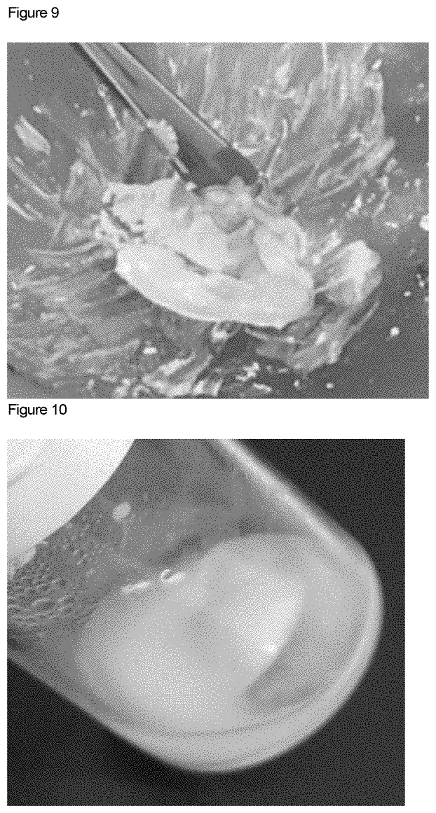

A few drops of anisole were added to the compound α (powder) of Example 2 to produce a paste-like coating liquid. It was confirmed that the coating liquid exhibited viscosity peculiar to polymers. FIG. 9 shows a photograph of the coating solution.

### Comparative Example 2

A coating liquid was produced in the same manner as in Example 4, except that the compound α (powder) of Comparative Example 1 was used in place of the compound α (powder) of Example 3. In the coating solution, it was confirmed that the powder of the compound α was not dissolved and precipitated. FIG. 10 shows a photograph of the coating solution.

### <Evaluation>

From the results of Examples 4 and 5, it was found that by using the compound α containing phosphorus and sulfur as constituent elements and having a disulfide bond, it is possible to produce a good coating liquid having various nature such as a solution state, a slurry state, and the like.

3. Fabrication of Sheet for Battery

(1) Electrolyte Layer

### Example 6

A slurry-like coating liquid having the following composition was prepared.

### [Composition of Coating Solution]

Li₃PS₄ solid electrolyte (Li₃PS₄ glass in Example 1): 95% by mass

The compound α (powder) of Example 3: 5% by mass

Anisole: 61 parts by mass based on 100 parts by mass of the total amount (total amount of solid content) of Li₃PS₄ solid electrolyte and the compound α (powder) of Example 3

Specifically, first, 0.4 mL of anisole was added to 0.04 g of the compound α (powder) of Example 3 to prepare a solution.

Next, 0.76 g of the Li₃PS₄ solid electrolyte was added to the solution, and the mixture was kneaded under the kneading condition described below using a planetary stirring defoamer (MAZERUSTAR KK-250S, manufactured by KURABO INDUSTRIES LTD.).

### [Conditions for Kneading]

Rotation speed: 1600 rpm

Revolution speed: 1600 rpm

Treatment time: 180 seconds, 3 times

Then, the sample was treated with an ultrasonic cleaner for 5 minutes, and then re-kneaded under the same kneading conditions as described above.

Then, another 0.1 mL of anisole was added to the sample, and the sample was further kneaded under the same kneading conditions as described above to obtain a slurry-like coating liquid (concentration of solid content in the slurry: 62% by mass).

The obtained coating liquid was applied on an aluminum foil having a size of 5 cm×10 cm to form a coating film. Subsequently, the coating film was dried at 60° C. for 10 hours to remove the solvent (anisole), thereby producing a solid electrolyte sheet (a sheet for a battery).

The thickness of the solid electrolyte sheet (dried coating film without the aluminum foil) was about 100 μm, and the ionic conductivity of the solid electrolyte sheet was 2×10⁻⁴ Scm⁻¹. The solid electrolyte sheet was not broken or peeled off from the aluminum foil even when the sheet was wound around a cylinder having a diameter of 16 mm.

In addition, a sheet for a battery (solid electrolyte sheet) was produced in the same manner as in Example 6, except that the compound α (powder) of Example 2 was used in place of the compound α (powder) of Example 3. This solid electrolyte sheet was evaluated in the same manner as in Example 6. The solid electrolyte sheet was not broken or peeled off from the aluminum foil even when the sheet was wound around a cylinder having a diameter of 16 mm.

### Example 7

### <Production of an Argyrodite-Type Solid Electrolyte>

1.284 g of Li₂S (manufactured by Furuuchi Chemical Corporation, 3 N powder 200 Mesh), 1.242 g of P₂S₅ (manufactured by Merck & Co., Inc.), and 0.474 g of LiCl (manufactured by NACALAI TESQUE, INC.) were reacted in the presence of a dispersion medium (n-heptane) by a mechanochemical method (mechanical milling) using a planetary ball mill (premium line PL-7 (Fritsch)) under conditions described below. The dispersion medium was then removed by drying to obtain a precursor of an argyrodite-type solid electrolyte.

### [Conditions for Mechanical Milling]

Sample mass: 3.0 g

Process: wet milling (in 11 mL of n-heptane)

Ball: ZrO₂-made, 5 mm in diameter, 106 g in total mass

Pot: ZrO₂-made, 80 mL in capacity

Rotation speed: 500 rpm

Treatment time: 20 hours

1 g of the precursor of an argyrodite-type solid electrolyte synthesized by mechanical milling was put into a quartz tube and heat-treated at 550° C. for 1 hour under an argon flow atmosphere.

The heat-treated argyrodite-type solid electrolyte was pulverized in a mortar and then, subjected to miniaturization treatment using a planetary ball mill (same apparatus as described above) to obtain an argyrodite-type solid electrolyte (powder).

### [Conditions for Miniaturization Treatment]

Sample mass: 0.8 g

Process: wet milling (in 13 mL of n-heptane and 0.25 mL of dibutyl ether)

Ball: ZrO₂-made, 1 mm in diameter, 40 g in total mass

Pot: ZrO₂-made, 80 mL in capacity

Rotation speed: 200 rpm

Treatment time: 20 hours

### [Composition of Coating Solution]

Argyrodite-type solid electrolyte: 95% by mass

The compound α (powder) of Example 3: 5% by mass

Anisole: 51 parts by mass based on 100 parts by mass of the total amount (total solid content) of the argyrodite-type solid electrolyte and the compound α (powder) of Example 3.

Specifically, first, 0.2 mL of anisole was added to 0.011 g of the compound α (powder) of Example 3 to prepare a solution. Then, 0.2 g of the argyrodite-type solid electrolyte was added to the solution, and the mixture was kneaded using a planetary stirring and defoaming device (the same apparatus as described above) under the following kneading conditions to obtain a slurry-like coating liquid (concentration of solid content in the slurry: 51% by mass).

### [Conditions for Kneading]

Rotation speed: 1600 rpm

Revolution speed: 1600 rpm

Treatment time: 180 seconds, 3 times

The obtained coating liquid was applied on an aluminum foil having a size of 5 cm×10 cm to form a coating film. Subsequently, the coating film was dried at 60° C. for 10 hours, and then dried under vacuum at 160° C. to remove the solvent (anisole), thereby producing a solid electrolyte sheet (a sheet for a battery).

The thickness of the solid electrolyte sheet was about 45 μm, and the ionic conductivity of the solid electrolyte sheet was 4.1×10⁻⁴ Scm⁻¹. The solid electrolyte sheet was not broken or peeled off from the aluminum foil even when the sheet was wound around a cylinder having a diameter of 16 mm. From this result, it was found that the compound α functions well as a binder.

### Comparative Example 3

A coating solution (solid content concentration: 62% by mass) in which all the amount of the solid content was occupied by the Li₃PS₄ solid electrolyte was tried to prepare in the same manner as in Example 6, except that the compound α (powder) of Example 3 was not blended. However, at such a solid content concentration of 62% by mass, the Li₃PS₄ solid electrolyte remained to be solid, so that a coating liquid could not be obtained. Therefore, the mixture was diluted to a solid content concentration of 53% by mass with anisole, whereby a slurry-like coating liquid was obtained. A solid electrolyte sheet (a sheet for a battery) was produced in the same manner as in Example 6 using this coating liquid (solid content concentration: 53% by mass). When the obtained solid electrolyte sheet was wound around a cylinder having a diameter of 16 mm, the sheet broke and peeled off from the aluminum foil.

(2) Positive Electrode (Composite Electrode Layer for Battery)

### Example 8

### <LiNbO₃ Coating on Positive Electrode Active Material>

200 mg of LiNi_{1/3}Mn_{1/3}Co_{1/3}O₂ (NMC) (manufactured by MTI Ltd.) was weighed and 0.3 ml of LiNb(OEt)₆ (manufactured by Alfa Aesar, lithium niobium ethoxide, 99+% (metal-based), 5% w/v in ethanol) was added thereto. Then, 0.7 mL of ultradehydrated ethanol (manufactured by FUJIFILM Wako Pure Chemical Corporation) was added thereto. The obtained sample was treated with an ultrasonic cleaner for 30 minutes and dried in an Ar atmosphere at 40° C. for 10 hours. Further, the sample was vacuum dried at 100° C. for 1 hour. The dried sample was placed in a desiccator with a relative humidity of about 40% to 50%, and the hydrolysis reaction was allowed to proceed for 10 hours. The sample after reacted was then heat-treated at 350° C. for 1 hour to obtain LiNbO₃-coated LiNi_{1/3}Mn_{1/3}Co_{1/3}O₂ (LiNbO₃-coated NMC). The LiNbO₃ content in the resulting LiNbO₃-coated NMC is 3% by mass.

### <Fabrication of Positive Electrode Sheet>

The LiNbO₃-coated LiNi_{1/3}Mn_{1/3}Co_{1/3}O₂ (LiNbO₃-coated NMC), the argyrodite-type solid electrolyte (SE) same as in Example 7, and acetylene black (AB) (manufactured by Denka Company Limited) were mixed in a mass ratio of LiNbO₃-coated NMC:SE:AB=70:30:5 (total mass of 0.24 g). To the obtained mixture, 0.1 mL of an anisole solution containing the compound α (powder) of Example 3 at a concentration of 10% by mass was added. The composition after addition of the anisole solution was LiNbO₃-coated NMC:SE:compound α:AB=70:30:5:5. The composition was kneaded, and anisole was further added to about 0.1 mL to 0.2 mL, and kneaded again to obtain a slurry (solid content concentration: 40 to 60% by mass). The obtained slurry was applied on an Al foil having a size of 5×10 cm to form a coating film. The coating film was dried at 60° C. for 10 hours and then vacuum-dried with 160° C. for 3 hours. The obtained sheet was punched out by a hole punch to obtain a positive electrode sheet having a diameter of 9.5 mm.

The positive electrode sheet was not broken or peeled off from the Al foil even when the sheet was wound around a cylinder having a diameter of 16 mm. In addition, the positive electrode sheet can be punched out satisfactorily by a hole punch. From these results, it was found that the compound α functions well as a binder.

### Example 9

### <Fabrication of All-Solid-State Battery>

Li₃PS₄ solid electrolyte (Li₃PS₄ glass of Example 1) (80 mg) was put into a cylindrical container having the SUS-axis on both sides and compacted to form a solid electrolyte layer. Next, the positive electrode sheet obtained in Example 8 was placed in a cylindrical container so as to stack on the solid electrolyte layer in layers, and an In foil and a Li foil were placed in this order on the side opposite to the electrode sheet in the solid electrolyte layer in the cylindrical container, followed by press-stacking to fabricate a test cell. The cell was constrained by a dedicated jig and subjected to tests of the following battery characteristics.

### <Initial Characteristics>

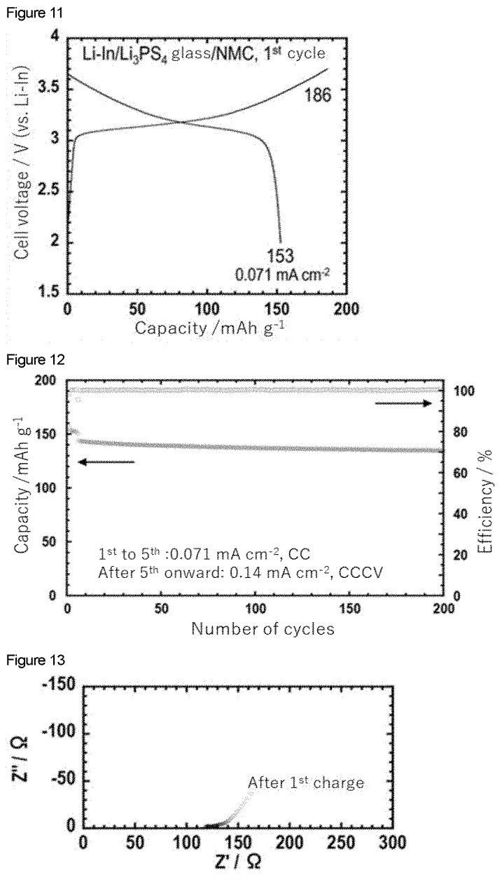

The results of initial charge and discharge are shown in FIG. 11.

From FIG. 11, it was found that the cell containing the positive electrode sheet of Example 8 can be charged and discharged without any noticeable side reaction.

### <Cycle Characteristics>

The results of the cycle characteristics are shown in FIG. 12.

From FIG. 12, it was found that the cell containing the positive electrode sheet of Example 8 had good cycle characteristics. From this result, it was found that the compound α functioned well as a binder of a positive electrode sheet.

### <AC Impedance Measurement>

A cell containing the positive electrode sheet of Example 8 was subjected to AC impedance measurement using “Solartron 1470E Cell test system” manufactured by Solartron Analytical to obtain a Cole-Cole plot. The results (Cole-Cole plot) are shown in FIG. 13.

From FIG. 13, it was found that the compound α functions well as a binder since the cell containing the positive electrode sheet of Example 8 has small interfacial resistance after charging.

(3) Negative Electrode (Composite Electrode Layer for Battery)

### Example 10

### <Fabrication of Anode Electrode Sheet>

Graphite (manufactured by Nippon Graphite Industries, Co., Ltd.), the argyrodite-type solid electrolyte (SE) of Example 7, and acetylene black (AB) were mixed in a mass ratio of graphite: SE:AB=60:40:1 (total mass of 0.23 g). To the obtained mixture, 0.1 mL of an anisole solution containing the compound α (powder) of Example 3 in a concentration of 10% by mass was added. The composition after addition of the anisole solution was graphite:SE:the compound α:AB=60:40:5:1. The composition was kneaded, and about 0.1 mL to 0.2 mL of another anisole was added thereto, and the mixture was kneaded again to obtain a slurry (solid content concentration: 40 to 60% by mass). The obtained slurry was applied on an Cu foil having a size of 5×10 cm to form a coating film. The coating film was dried at 60° C. for 10 hours and then vacuum-dried at 160° C. for 3 hours. The obtained sheet was punched out by a hole punch to obtain a negative electrode sheet having a diameter of 9.5 mm.

The negative electrode sheet was not broken or peeled off from the Cu foil even when the sheet was wound around a cylinder having a diameter of 16 mm. In addition, the negative electrode sheet can be punched out satisfactorily by a hole punch. From these results, it was found that the compound α functions well as a binder.

### Example 11

### <Fabrication of All-Solid-State Battery>

Li₃PS₄ solid electrolyte (Li₃PS₄ glass of Example 1) (80 mg) was put into a cylindrical container having the SUS-axis on both sides and compacted to form a solid electrolyte layer. Next, the negative electrode sheet obtained in Example 10 was placed in a cylindrical container so as to stack on the solid electrolyte layer, and an In foil and a Li foil were placed in this order on the side opposite to the electrode sheet of the solid electrolyte layer in the cylindrical container, followed by press-stacking to fabricate a test cell. The cell was constrained with a dedicated jig, and tested for the following battery characteristics.

### <Initial Characteristics>

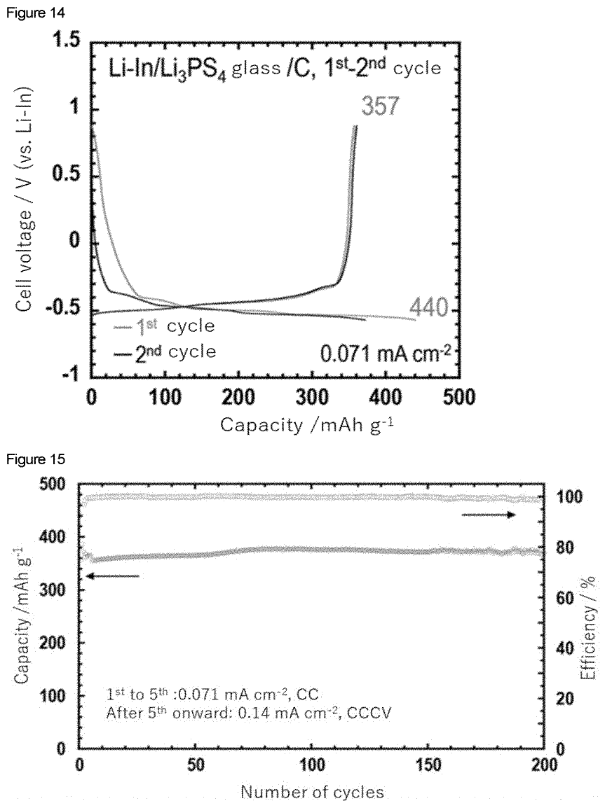

The measurement results of initial charge and discharge are shown in FIG. 14.

From the results of FIG. 14, it was found that the cell containing the negative electrode sheet of Example 9 had a large irreversible capacity in the initial cycle, and gradually became stable from the second cyde onward.

<Cycle Characteristics>

The measurement results of the cyde characteristics are shown in FIG. 15.

From the results of FIG. 15, it is understood that the cell containing the negative electrode sheet of Example 9 has good cycle characteristics. From this fact, it was found that the compound α functions well as a binder of a negative electrode sheet.

### Example 12

A compound α (powder) was obtained in the same manner as in Example 1, except that I₂ was added to Li₃PS₄ glass so that the molar ratio of Li₃PS₄:I₂ was changed to be 4:5 in the “Production of compound α” in Example 1.

Raman spectroscopy was carried out for the obtained compound α (powder) in the same manner as in Example 1, a peak near the Raman shift 475 cm⁻¹ (477 cm⁻¹) was observed. In the description of Examples 12 and subsequent Examples, when a peak was confirmed near the Raman shift 475 cm⁻¹, another peak corresponding to the peak B was also confirmed.

### Example 13

In the “Production of compound α” in Example 1, the molar ratio of a Li₃PS₄ glass and I₂ was changed to be Li₃PS₄:I₂=1:1, a Li₃PS₄ glass and I₂ were solved in a solvent (anisole) to obtain a solution instead of a mechano-chemical method, and the solution was reacted at 60° C. for 24 hours with stirring. The solvent was then removed by drying to obtain a compound α (powder).

Raman spectroscopy was carried out for the obtained compound α (powder) in the same manner as in Example 1, a peak near the Raman shift 475 cm⁻¹ (477 cm⁻¹) was observed.

XRD was performed on the obtained compound α (powder) in the same manner as in Example 1, and a peak attributable to LiI was observed. This fact suggested that the reaction shown in Reaction Scheme (1) or (2) proceeded.

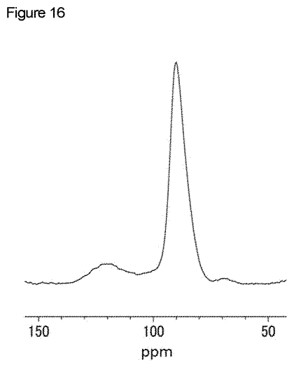

Solid-state ³¹P-NMR spectrum was measured for the obtained compound α (powder) in the same manner as in Example 1, and a peak was observed at 120 ppm of chemical shifts as shown in FIG. 16.

Solid-state ⁷Li-NMR was measured for the obtained compound α (powder) in the same manner as in Example 1, and no peak attributable to LiI was observed. Therefore, it was determined that the crystal phase of LiI coexisting with the compound α was h-LiI.

A sheet for a battery (solid electrolyte sheet) was fabricated using the obtained compound α (powder) and evaluated in the same manner as in Example 6. When the solid electrolyte sheet was wound around a cylinder having a diameter of 16 mm, the sheet was not broken or peeled from the aluminum foil.

Further, n-heptane was added to the solution after the synthesis reaction of the compound α, and the mixture was subjected to solid-liquid separation to collect a solid portion. This solid portion was dried to obtain a powder sample. Raman spectroscopy was carried out for this powder sample in the same manner as in Example 1, and a peak near the Raman shift 475 cm⁻¹ (479 cm⁻¹), which is attributable to a disulfide (S—S) bond of a P—S—S chain, was observed.

### Example 14

A compound α (powder) was obtained in the same manner as in Example 13, except that the reaction time was changed to 72 hours.

Raman spectroscopy was carried out for the obtained compound α (powder) in the same manner as in Example 1, and a peak near the Raman shift 475 cm⁻¹(477 cm⁻¹) was observed.

A sheet for a battery (solid electrolyte sheet) was fabricated using the obtained compound α (powder) and evaluated in the same manner as in Example 6. When the solid electrolyte sheet was wound around a cylinder having a diameter of 16 mm, the sheet was not broken or peeled from the aluminum foil. The ionic conductivity was 4.2×10⁻⁴ Scm⁻¹.

In the fabrication of the solid electrolyte sheet, when the concentration of the compound α in the coating solution was 10% by mass, the ionic conductivity of the solid electrolyte sheet was 2.6×10⁻⁴ Scm⁻¹. When the concentration of the compound α in the coating solution was 15% by mass, the ionic conductivity of the solid electrolyte sheet was 2.4×10⁻⁴ Scm⁻¹.

### Example 15

A compound α (powder) was obtained in the same manner as in Example 13, except that the reaction time was changed to 96 hours.

Raman spectroscopy was carried out for the obtained compound α (powder) in the same manner as in Example 1, and a peak near the Raman shift 475 cm⁻¹ (477 cm⁻¹) was observed.

Solid-state ³¹P-NMR spectrum of the obtained compound α (powder) was measured in the same manner as in Example 1, and a peak was observed at 120 ppm of chemical shifts.

Further, a sheet for a battery (solid electrolyte sheet) was fabricated using the obtained compound α (powder) and evaluated in the same manner as in Example 6. The solid electrolyte sheet was not broken or peeled off from the aluminum foil even when the sheet was wound around a cylinder having a diameter of 16 mm. The ionic conductivity was 1.7×10⁻⁴ Scm⁻¹.

Further, the suitability to a positive electrode sheet of the obtained compound α (powder) was evaluated. Specifically, an argyrodite-type solid electrolyte (SE) was obtained in the same manner as in Example 7, except that the compound α (powder) obtained by Example 15 described above was used in place of the compound α (powder) of Example 3. Next, a positive electrode sheet was obtained in the same manner as in Example 8, except that the compound α (powder) obtained by Example 15 described above was used in place of the compound α (powder) of Example 3, and the solid electrolyte (SE) obtained in the above was used as the Li₃PS₄ solid electrolyte (SE). The obtained positive electrode sheet was not broken or peeled off from the Al foil even when the sheet was wound around a cylinder having a diameter of 16 mm. In addition, the positive electrode sheet can be punched out satisfactorily by a hole punch. From this result, it was found that the compound α functions well as a binder.

### Example 16

A compound α (powder) was obtained in the same manner as in Example 13, except that the reaction time was changed to 216 hours.

Raman spectroscopy was carried out for the obtained compound α (powder) in the same manner as in Example 1, and a peak near the Raman shift 475 cm⁻¹ (477 cm⁻¹) was observed.

Solid-state ³¹P-NMR spectrum was measured for the obtained compound α (powder) in the same manner as in Example 1, and a peak was observed at 120 ppm of chemical shifts.

### Example 17

A compound α (powder) was obtained in the same manner as in Example 13, except that the reaction temperature was changed to 80° C.

Raman spectroscopy was carried out for the obtained compound α (powder) in the same manner as in Example 1, and a peak near the Raman shift 475 cm⁻¹ (477 cm⁻¹) was observed.

A sheet for a battery (solid electrolyte sheet) was fabricated using the obtained compound α (powder) and evaluated in the same manner as in Example 6. When the solid electrolyte sheet was wound around a cylinder having a diameter of 16 mm, the sheet was not broken or peeled from the aluminum foil.

### Example 18

A compound α (powder) was obtained in the same manner as in Example 13, except that the reaction temperature was changed to 100° C., and the reaction time was changed to 1 hour.

Raman spectroscopy was carried out for the obtained compound α (powder) in the same manner as in Example 1, and a peak near the Raman shift 475 cm⁻¹ (477 cm⁻¹) was observed.

XRD was performed on the obtained compound α (powder) in the same manner as in Example 1, and a peak attributable to LiI was observed. This result suggested that the reaction shown in Reaction Scheme (1) or (2) proceeded.

A sheet for a battery (solid electrolyte sheet) was fabricated using the obtained compound α (powder) and evaluated in the same manner as in Example 6. When the solid electrolyte sheet was wound around a cylinder having a diameter of 16 mm, the sheet was not broken or peeled from the aluminum foil.

### Example 19

A compound α (powder) was obtained in the same manner as in Example 13, except that the molar ratio of a Li₃PS₄ glass and I₂ was changed to be Li₃PS₄:I₂=4:5.

Raman spectroscopy was carried out for the obtained compound α (powder) in the same manner as in Example 1, and a peak near the Raman shift 475 cm⁻¹ (477 cm⁻¹) was observed.

XRD was performed on the obtained compound α (powder) in the same manner as in Example 1, and a peak attributable to LiI was observed. This result suggested that the reaction shown in Reaction Scheme (1) or (2) proceeded.

Solid-state ⁷Li-NMR was measured for the obtained compound α (powder) in the same manner as in Example 1, and no peak attributable to LiI was observed. Therefore, it was determined that the crystal phase of LiI coexisting with the compound α was h-LiI.

A sheet for a battery (solid electrolyte sheet) was fabricated using the obtained compound α (powder) and evaluated in the same manner as in Example 6. When the solid electrolyte sheet was wound around a cylinder having a diameter of 16 mm, the sheet was not broken or peeled from the aluminum foil. The ionic conductivity was 3.9×10⁻⁴ Scm⁻¹.

### Example 20

A compound α (powder) was obtained in the same manner as in Example 19, except that the reaction temperature was changed to 80° C., and the reaction time was changed to 96 hours.

Raman spectroscopy was carried out for the obtained compound α (powder) in the same manner as in Example 1, and a peak near the Raman shift 475 cm⁻¹ (477 cm⁻¹) was observed.

Further, a sheet for a battery (solid electrolyte sheet) was fabricated using the obtained compound α (powder) and evaluated in the same manner as in Example 6. The solid electrolyte sheet was not broken or peeled off from the aluminum foil even when the sheet was wound around a cylinder having a diameter of 16 mm.

### Example 21

A compound α (powder) was obtained in the same manner as in Example 19, except that the reaction temperature was changed to 100° C., and the reaction time was changed to 24 hours.

Raman spectroscopy was carried out for the obtained compound α (powder) in the same manner as in Example 1, and a peak near the Raman shift 475 cm⁻¹ (477 cm⁻¹) was observed.

### Example 22

A compound α (powder) was obtained in the same manner as in Example 13, except that the molar ratio of a Li₃PS₄ glass and I₂ was changed to be Li₃PS₄:I₂=2:1, and an the reaction temperature was changed to 60° C.

Raman spectroscopy was carried out for the obtained compound α (powder) in the same manner as in Example 1, and a peak near the Raman shift 475 cm⁻¹ (477 cm⁻¹) was observed.

XRD was performed on the obtained compound α (powder) in the same manner as in Example 1, and a peak attributable to LiI was observed. This result suggested that the reaction shown in Reaction Scheme (1) or (2) proceeded.

Solid-state ⁷Li-NMR was measured for the obtained compound α (powder) in the same manner as in Example 1, and no peak attributable to LiI was observed. Therefore, it was determined that the crystal phase of LiI coexisting with the compound α was h-LiI.

### Example 23

A compound α (powder) was obtained in the same manner as in Example 22, except that the molar ratio of a Li₃PS₄ glass and I₂ was changed to be Li₃PS₄:I₂=4:3.

Raman spectroscopy was carried out for the obtained compound α (powder) in the same manner as in Example 1, and a peak near the Raman shift 475 cm⁻¹ (477 cm⁻¹) was observed.

XRD was performed on the obtained compound α (powder) in the same manner as in Example 1, and a peak attributable to LiI was observed. This result suggested that the reaction shown in Reaction Scheme (1) or (2) proceeded.

Solid-state ⁷Li-NMR was measured for the obtained compound α (powder) in the same manner as in Example 1, and no peak attributable to LiI was observed. Therefore, it was determined that the crystal phase of LiI coexisting with the compound α was h-LiI.

### Example 24

A compound α (powder) was obtained in the same manner as in Example 22, except that the molar ratio of a Li₃PS₄ glass and I₂ was changed to be Li₃PS₄:I₂=1:1, and the reaction temperature was changed to room temperature (23° C.).

Raman spectroscopy was carried out for the obtained compound α (powder) in the same manner as in Example 1, and a peak near the Raman shift 475 cm⁻¹ (477 cm⁻¹) was observed.

### Example 25

A compound α (powder) was obtained in the same manner as in Example 13, except that Br₂ was used in place of I₂, and the molar ratio of a Li₃PS₄ glass and Br₂ was changed to be Li₃PS₄:Br₂=1:1.

Raman spectroscopy was carried out for the obtained compound α (powder) in the same manner as in Example 1, and a peak near the Raman shift 475 cm⁻¹(477 cm⁻¹) was observed.

XRD was performed on the obtained compound α (powder) in the same manner as in Example 1, and a peak attributable to LiBr was observed. This result suggested that the reaction shown in the Reaction Scheme (1) or (2) (where I in the Scheme is replaced with Br) proceeded.

### Example 26

A compound α (powder) was obtained in the same manner as in Example 25, except that dibutyl ether was used in place of anisole as a solvent.

Raman spectroscopy was carried out for the obtained compound α (powder) in the same manner as in Example 1, and a peak near the Raman shift 475 cm⁻¹ (477 cm⁻¹) was observed.

XRD was performed on the obtained compound α (powder) in the same manner as in Example 1, and a peak attributable to LiBr was observed. This result suggested that the reaction shown in the Reaction Scheme (1) or (2) (where I in the Scheme is replaced with Br) proceeded.

### Example 27

A Li₄P₂S₇ glass was obtained in the same manner as in the “Production of Li₃PS₄ glass” in Example 1, except that the charge amount of Li₂S and P₂S₅ was set to a predetermined ratio (Li₂S: P₂S₅=2:1 in a molar ratio).

A compound α (powder) was obtained in the same manner as in Example 1, except that a Li₄P₂S₇ glass was used in place of the Li₃PS₄ glass, and the ratio of a Li₄P₂S₇ glass and I₂ was changed to be Li₄P₂S₇:I₂=2:1.

Raman spectroscopy was carried out for the obtained compound α (powder) in the same manner as in Example 1, and a peak near the Raman shift 475 cm⁻¹ (480 cm⁻¹) was observed.

### Example 28

A compound α (powder) was obtained in the same manner as in Example 27, except that the molar ratio of a Li₄P₂S₇ glass and I₂ was changed to be Li₄P₂S₇:I₂=4:3.

Raman spectroscopy was carried out for the obtained compound α (powder) in the same manner as in Example 1, and a peak near the Raman shift 475 cm⁻¹ (480 cm⁻¹) was observed.

### Example 29

A compound α (powder) was obtained in the same manner as in Example 27, except that the molar ratio of a Li₄P₂S₇ glass and I₂ was changed to be Li₄P₂S₇:I₂=8:7.

Raman spectroscopy was carried out for the obtained compound α (powder) in the same manner as in Example 1, and a peak near the Raman shift 475 cm⁻¹ (480 cm⁻¹) was observed.

Further, XRD was performed on the obtained compound α (powder) in the same manner as in Example 1, and a peak attributable to LiI was observed. This result suggested that the reaction shown in Reaction Scheme (1) or (2) proceeded.

### Example 30

A compound α (powder) was obtained in the same manner as in Example 27, except that the molar ratio of a Li₄P₂S₇ glass and I₂ was changed to be Li₄P₂S₇:I₂=1:1.

Raman spectroscopy was carried out for the obtained compound α (powder) in the same manner as in Example 1, and a peak near the Raman shift 475 cm⁻¹(480 cm⁻¹) was observed.

XRD was performed on the obtained compound α (powder) in the same manner as in Example 1, and a peak attributable to LiI was observed. This result suggested that the reaction shown in Reaction Scheme (1) or (2) proceeded.

Further, a sheet for a battery (solid electrolyte sheet) was fabricated using the obtained compound α(powder) and evaluated in the same manner as in Example 6. The solid electrolyte sheet was not broken or peeled off from the aluminum foil even when the sheet was wound around a cylinder having a diameter of 16 mm. The ionic conductivity was 2.8×10⁻⁴ Scm⁻¹.

### Example 31

A compound α (powder) was obtained in the same manner as in Example 27, except that the molar ratio of a Li₄P₂S₇ glass and I₂ was changed to be Li₄P₂S₇:I₂=2:3.

Raman spectroscopy was carried out for the obtained compound α (powder) in the same manner as in Example 1, and a peak near the Raman shift 475 cm⁻¹ (480 cm⁻¹) was observed.

Further, XRD was performed on the obtained compound α (powder) in the same manner as in Example 1, and a peak attributable to LiI was observed. This result suggested that the reaction shown in Reaction Scheme (1) or (2) proceeded.

### Example 32

A compound α was obtained in the same manner as in Example 13, except that a Li₄P₂S₇ glass was used instead of the Li₃PS₄ glass, the molar ratio of a Li₄P₂S₇ glass and I₂ was changed to be Li₄P₂S₇:I₂=1:1, and the reaction time was changed to 6 hours.

Raman spectroscopy was carried out for the obtained compound α (powder) in the same manner as in Example 1, and a peak near the Raman shift 475 cm⁻¹ (477 cm⁻¹) was observed.

### Example 33

A compound α (powder) was obtained in the same manner as in Example 13, except that Li₂S and P₂S₅ were used in place of Li₃PS₄, and the molar ratio of Li₂S, P₂S₅, and I₂ was changed to be Li₂S:P₂S₅:I₂=3:1:2.

Raman spectroscopy was carried out for the obtained compound α (powder) in the same manner as in Example 1, and a peak near the Raman shift 475 cm⁻¹ (477 cm⁻¹) was observed.

### Example 34

A compound α (powder) was obtained in the same manner as in Example 33, except that the reaction temperature was changed to 100° C.

Raman spectroscopy was carried out for the obtained compound α (powder) in the same manner as in Example 1, and a peak near the Raman shift 475 cm⁻¹ (477 cm⁻¹) was observed.

Further, XRD was performed on the obtained compound α (powder) in the same manner as in Example 1, and a peak attributable to LiI was observed. This result suggested that the reaction shown in Reaction Scheme (1) or (2) proceeded.

### Example 35

A compound α (powder) was obtained in the same manner as in Example 33, except that dibutyl ether was used in place of anisole as a solvent.

Raman spectroscopy was carried out for the obtained compound α (powder) in the same manner as in Example 1, and a peak near the Raman shift 475 cm⁻¹ (477 cm⁻¹) was observed.

### Example 36

A compound α (powder) was obtained in the same manner as in Example 1, except that Na₃PS₄ was used in place of Li₃PS₄, and the molar ratio of Na₃PS₄ and I₂ was changed to be Na₃PS₄:I₂=2:1.

Raman spectroscopy was carried out for the obtained compound α (powder) in the same manner as in Example 1, and a peak near the Raman shift 475 cm⁻¹ (474 cm⁻¹) was observed.

XRD was performed on the obtained compound α (powder) in the same manner as in Example 1, and a peak attributable to NaI was observed. This result suggested that the reaction shown in the Reaction Scheme (1) or (2) (where Li in the Scheme is replaced with Na) proceeded.

### Example 37

A compound α (powder) was obtained in the same manner as in Example 36, except that the molar ratio of Na₃PS₄ and I₂ was changed to be Na₃PS₄:I₂=4:3.

Raman spectroscopy was carried out for the obtained compound α (powder) in the same manner as in Example 1, and a peak near the Raman shift 475 cm⁻¹ (474 cm⁻¹) was observed.

XRD was performed on the obtained compound α (powder) in the same manner as in Example 1, and a peak attributable to NaI was observed. This result suggested that the reaction shown in the Reaction Scheme (1) or (2) (where Li in the Scheme is replaced with Na) proceeded.

### Example 38

A compound α (powder) was obtained in the same manner as in Example 36, except that the molar ratio of Na₃PS₄ and I₂ was changed to be Na₃PS₄:I₂=1:1.

Raman spectroscopy was carried out for the obtained compound α (powder) in the same manner as in Example 1, and a peak near the Raman shift 475 cm⁻¹ (474 cm⁻¹) was observed.

XRD was performed on the obtained compound α (powder) in the same manner as in Example 1, and a peak attributable to NaI was observed. This result suggested that the reaction shown in the Reaction Scheme (1) or (2) (where Li in the Scheme is replaced with Na) proceeded.

### Example 39

A compound α (powder) was obtained in the same manner as in Example 36, except that the molar ratio of Na₃PS₄ and I₂ was changed to be Na₃PS₄:I₂=4:5.

Raman spectroscopy was carried out for the obtained compound α (powder) in the same manner as in Example 1, and a peak near the Raman shift 475 cm⁻¹ (474 cm⁻¹) was observed.

XRD was performed on the obtained compound α (powder) in the same manner as in Example 1, and a peak attributable to NaI was observed. This result suggested that the reaction shown in the Reaction Scheme (1) or (2) (where Li in the Scheme is replaced with Na) proceeded.

### Comparative Example 4

A sheet for a battery (solid electrolyte sheet) was fabricated and evaluated in the same manner as in Example 6, except that styrene-butadiene-based thermoplastic elastomer (SBS) was used in place of the compound α (powder). The solid electrolyte sheet was not broken or peeled off from the aluminum foil even when the sheet was wound around a cylinder having a diameter of 16 mm. However, the ionic conductivity was as poor as 1.1×10⁻⁴ Scm⁻¹.

While the invention has been described by some embodiments and Examples, the invention is not limited thereto, and various modifications can be made within the scope of the gist of the invention. The invention encompasses substantially the same configurations as those described in the embodiments, for example, configurations having the same functions, methods, and results, or configurations having the same objects and effects. In addition, the invention encompasses a configuration in which a non-essential part of the configuration described in the above embodiment is replaced with other configuration. Further, the invention also encompasses a configuration which achieves the same operation and effect as the configuration described in the above embodiment or a configuration which can achieve the same purpose. Further, the invention encompasses a configuration in which a known technique is added to the configuration described in the above embodiment.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. A compound comprising phosphorus and sulfur as constituent elements and having a peak in Raman spectroscopy, the peak being attributable to a disulfide bond bonding between two phosphorus atoms.

2. The compound according to claim 1, comprising one or more elements selected from the group consisting of lithium, sodium, magnesium, and aluminum as constituent elements.

3. A binder for a battery, comprising the compound according to claim 1.

4. The binder for a battery according to claim 3, comprising a halogen.

5. The binder for a battery according to claim 4, wherein the halogen is iodine or bromine.

6. A composite electrode layer for a battery or an electrolyte layer for a battery, comprising the binder for a battery according to claim 3.

7. The composite electrode layer for a battery or the electrolyte layer for a battery according to claim 6, further comprising a solid electrolyte other than the binder for a battery.

8. A sheet for a battery comprising one or more selected from the group consisting of the composite electrode layer for a battery and the electrolyte layer for a battery according to claim 6.

9. A battery comprising the compound according to claim 1.

10. A method of producing a compound, comprising:
adding an oxidizing agent to a raw material compound comprising phosphorus and sulfur as constituent elements, and
reacting the raw material compound and the oxidizing agent.

11. The method of producing a compound according to claim 10, wherein the raw material compound comprises one or more elements selected from the group consisting of lithium, sodium, magnesium, and aluminum as constituent elements.

12. The method of producing a compound according to claim 10, wherein the raw material compound comprises a PS₄ structure.

13. The method of producing a compound according to claim 10, wherein the oxidizing agent is a halogen simple substance.

14. The method of producing a compound according to claim 13, wherein the halogen simple substance is iodine or bromine.

15. The method of producing a compound according to claim 10, wherein the raw material compound and the oxidizing agent are reacted by one or more selected from the group consisting of physical energy, thermal energy, and chemical energy.

16. The method of producing a compound according to claim 10, wherein the raw material compound and the oxidizing agent are reacted in a liquid.
